(19) United States
(12) Patent Application Publication
(10) Pub. No.: US 2021/0241205 A1
(43) Pub. Date: Aug. 5, 2021

(54) SYSTEM FOR ALLOCATING AND DEPLOYING RESOURCES BASED ON A LOGICAL RULESET

(71) Applicant: Gigawarp Technologies LLC, San Antonio, TX (US)

(72) Inventors: Larry B. Cochran, San Antonio, TX (US); Anthony H. Scow, San Antonio, TX (US); Michael T. Cronin, Live Oak, TX (US)

(21) Appl. No.: 17/162,846

(22) Filed: Jan. 29, 2021

Related U.S. Application Data
(60) Provisional application No. 62/968,899, filed on Jan. 31, 2020.

(51) Int. Cl. G06Q 10/06; G06Q 20/40; G06Q 30/00; G06Q 10/10; G06F 16/28; G06F 16/23

(52) U.S. Cl. CPC G06Q 10/063112; G06Q 20/405; G06Q 10/06315; G06Q 30/018; G06Q 30/0205; G06Q 10/067; G06F 16/285; G06F 16/2379; G06Q 10/103

(57) ABSTRACT

Described are platforms, systems, and methods for assigning and deploying resources for incoming transactions. In one aspect, a method comprises maintaining, in a datastore, the set of logic rules comprising cascading or nested logic rules; determining a Boolean-based visual representation of the set logic rules and a logic chain formed by the set logic rules as a dynamic tree view, wherein the dynamic tree view depicts the set of logic rules as cascading or nested logic strings for human readability; providing the dynamic tree view to a user-interface; and receiving updates to the set of logic rules from the user-interface based on a user's interaction with the dynamic tree view.

### CROSS-REFERENCE TO RELATED APPLICATIONS

This application claims the priority and benefit of U.S. Application No. 62/968,899, filed Jan. 31, 2020, and entitled: SYSTEM FOR ALLOCATING AND DEPLOYING RESOURCES BASED ON A LOGICAL RULESET, the entire content of which is incorporated herein by reference in its entirety.

### BACKGROUND

The allocation of resources includes the diligent deployment of resources to tasks based on their skill set and timelines. Systems are often forced to allocate resources by virtue of situations rather than strategic decisions. Implementations of specific logic designed to increase efficiency can greatly improve the overall effectiveness of resource allocation.

### SUMMARY

Embodiments of the present disclosure are generally directed to systems, platforms, and methods for assigning resources to a transaction. More particularly, embodiments of the present disclosure are directed to a system that assigns resources to a transaction based on a ruleset that includes a series of logic rules (ruleset). In some embodiments, the described resource assignment system provides resource territory generation and assignment as well as a rule visualization of complex rules. The rule visualization can be employed to understand how a platform is automatically assigning resources to, for example, loss events. In some embodiments, the rule visualization is presented as a tree view. In some embodiments, the resource territory generation and assignment solution integrates advanced mapping capabilities that permit users to create resource-oriented territories directly within a map view.

Accordingly, in one aspect, disclosed herein disclosed herein are systems comprising: a personal computing device; one or more processors; and a computer-readable storage device coupled to the one or more processors. The storage device having instructions stored thereon which, when executed by the one or more processors, cause the one or more processors to perform operations. These operations comprise: maintaining, in a datastore, a chain of categorization logic rules and a chain of resource logic rules, wherein the chain of categorization logic rules and the chain of resource logic rules are updated through a user-interface based on a respective Boolean-based visual representation of the chain of categorization logic rules and the chain of resource logic rules, and wherein each of the Boolean-based visual representations includes a representation of a logic chain formed by the respective chain of logic rules; receiving transaction data regarding a transaction, the transaction data comprising key attributes of the transaction; processing the transaction data through the chain of categorization logic rules to categorize the transaction based on the key attributes; processing the transaction data through the chain of resource logic rules to determine a resource to assign to the transaction, the chain of resource logic rules determined based on the categorization of the transaction; and deploying the resource to the transaction by providing a notification to the resource via the personal computing device. In some embodiments, the personal computing device is associated with the resource. In some embodiments, deploying the resource to the transaction comprises providing a notification to the resource via a personal computing device associated with the resource. In some embodiments, the notification comprises requirements assigned to the resources and instructions for the resource. In some embodiments, the instructions comprise traveling to a location associated with the transaction and assessing the transaction. In some embodiments, the key attributes comprise deadlines and contact information. In some embodiments, the transaction comprises a loss event. In some embodiments, the transaction data comprises a first notice of loss. In some embodiments, the resource is assigned to the transaction based on a coverage area associated with the resource. In some embodiments, the resource is assigned to the transaction based on a proximity to the transaction. In some embodiments, the proximity to the transaction is determined by a current location of the resource, the current location provided by a personal computing device associated with the resource. In some embodiments, the resource is assigned to the transaction based a skill set of the resource, licenses associated with the resource, certifications associated with the resource, availability of the resource, or overflow requirements. In some embodiments, the resource is assigned to the transaction based on a customized territory associated with the resource. In some embodiments, the customized territory is associated with the resource based on a current location of the resource. In some embodiments, the customized territory is determined based on radii or custom polygons that are tailored based on a topography of a region. In some embodiments, the topography of the region includes man-made barriers and natural barriers. In some embodiments, the chain of categorization logic rules and the chain of resource logic rules each comprises cascading and nested logic rules respectively. In some embodiments, the operations comprise: presenting, via a user-interface, the chain of categorization logic rules or the chain of resource logic rules as a tree view. In some embodiments, the tree view comprises a Boolean-based visual representation of the respective logic rules. In some embodiments, the operations comprise: receiving updates to the chain of categorization logic rules or the chain of resource logic rules from the user-interface. In some embodiments, the resource comprises an individual, a vehicle, a piece of equipment, or an Internet of Things (IoT) device.

In a related yet separate aspect, disclosed herein are methods for assigning and deploying resources for incoming transactions. The methods are executed by one or more processors and comprise: maintaining, in a datastore, a chain of categorization logic rules and a chain of resource logic rules, wherein the chain of categorization logic rules and the chain of resource logic rules are updated through a user-interface based on a respective Boolean-based visual representation of the chain of categorization logic rules and the chain of resource logic rules, and wherein each of the Boolean-based visual representations includes a representation of a logic chain formed by the respective chain of logic rules; receiving transaction data regarding a transaction, the transaction data comprising key attributes of the transaction; processing the transaction data through the chain of categorization logic rules to categorize the transaction based on the key attributes; processing the transaction data through the chain of resource logic rules to determine a resource to assign to the transaction, the chain of resource logic rules determined based on the categorization of the transaction; and deploying the resource to the transaction by providing a notification to the resource via the personal computing device. In some embodiments, the personal computing device is associated with the resource. In some embodiments, deploying the resource to the transaction comprises providing a notification to the resource via a personal computing device associated with the resource. In some embodiments, the notification comprises requirements assigned to the resources and instructions for the resource. In some embodiments, the instructions comprise traveling to a location associated with the transaction and assessing the transaction. In some embodiments, the key attributes comprise deadlines and contact information. In some embodiments, the transaction comprises a loss event. In some embodiments, the transaction data comprises a first notice of loss. In some embodiments, the resource is assigned to the transaction based on a coverage area associated with the resource. In some embodiments, the resource is assigned to the transaction based on a proximity to the transaction. In some embodiments, the proximity to the transaction is determined by a current location of the resource, the current location provided by a personal computing device associated with the resource. In some embodiments, the resource is assigned to the transaction based a skill set of the resource, licenses associated with the resource, certifications associated with the resource, availability of the resource, or overflow requirements. In some embodiments, the resource is assigned to the transaction based on a customized territory associated with the resource. In some embodiments, the customized territory is associated with the resource based on a current location of the resource. In some embodiments, the customized territory is determined based on radii or custom polygons that are tailored based on a topography of a region. In some embodiments, the topography of the region includes man-made barriers and natural barriers. In some embodiments, the chain of categorization logic rules and the chain of resource logic rules each comprises cascading and nested logic rules respectively. In some embodiments, the methods comprise: presenting, via a user-interface, the chain of categorization logic rules or the chain of resource logic rules as a tree view. In some embodiments, the tree view comprises a Boolean-based visual representation of the respective logic rules. In some embodiments, the methods comprise: receiving updates to the chain of categorization logic rules or the chain of resource logic rules from the user-interface. In some embodiments, the resource comprises an individual, a vehicle, a piece of equipment, or an Internet of Things (IoT) device.

In a related yet separate aspect, disclosed herein are non-transitory computer-readable storage media that are coupled to one or more processors. The one or more non-transitory computer-readable storage media having instructions stored thereon which, when executed by the one or more processors, cause the one or more processors to perform operations. These operations comprise: maintaining, in a datastore, a chain of categorization logic rules and a chain of resource logic rules, wherein the chain of categorization logic rules and the chain of resource logic rules are updated through a user-interface based on a respective Boolean-based visual representation of the chain of categorization logic rules and the chain of resource logic rules, and wherein each of the Boolean-based visual representations includes a representation of a logic chain formed by the respective chain of logic rules; receiving transaction data regarding a transaction, the transaction data comprising key attributes of the transaction; processing the transaction data through the chain of categorization logic rules to categorize the transaction based on the key attributes; processing the transaction data through the chain of resource logic rules to determine a resource to assign to the transaction, the chain of resource logic rules determined based on the categorization of the transaction; and deploying the resource to the transaction by providing a notification to the resource via the personal computing device. In some embodiments, the personal computing device is associated with the resource. In some embodiments, deploying the resource to the transaction comprises providing a notification to the resource via a personal computing device associated with the resource. In some embodiments, the notification comprises requirements assigned to the resources and instructions for the resource. In some embodiments, the instructions comprise traveling to a location associated with the transaction and assessing the transaction. In some embodiments, the key attributes comprise deadlines and contact information. In some embodiments, the transaction comprises a loss event. In some embodiments, the transaction data comprises a first notice of loss. In some embodiments, the resource is assigned to the transaction based on a coverage area associated with the resource. In some embodiments, the resource is assigned to the transaction based on a proximity to the transaction. In some embodiments, the proximity to the transaction is determined by a current location of the resource, the current location provided by a personal computing device associated with the resource. In some embodiments, the resource is assigned to the transaction based a skill set of the resource, licenses associated with the resource, certifications associated with the resource, availability of the resource, or overflow requirements. In some embodiments, the resource is assigned to the transaction based on a customized territory associated with the resource. In some embodiments, the customized territory is associated with the resource based on a current location of the resource. In some embodiments, the customized territory is determined based on radii or custom polygons that are tailored based on a topography of a region. In some embodiments, the topography of the region includes man-made barriers and natural barriers. In some embodiments, the chain of categorization logic rules and the chain of resource logic rules each comprises cascading and nested logic rules respectively. In some embodiments, the operations comprise: presenting, via a user-interface, the chain of categorization logic rules or the chain of resource logic rules as a tree view. In some embodiments, the tree view comprises a Boolean-based visual representation of the respective logic rules. In some embodiments, the operations comprise: receiving updates to the chain of categorization logic rules or the chain of resource logic rules from the user-interface. In some embodiments, the resource comprises an individual, a vehicle, a piece of equipment, or an Internet of Things (IoT) device.

In a related yet separate aspect, disclosed herein are methods for receiving updates to a set of logic rules. These method comprise: maintaining, in a datastore, the set of logic rules comprising cascading or nested logic rules; determining a Boolean-based visual representation of the set logic rules and a logic chain formed by the set logic rules as a dynamic tree view, wherein the dynamic tree view depicts the set of logic rules as cascading or nested logic strings for human readability; providing the dynamic tree view to a user-interface; and receiving updates to the set of logic rules from the user-interface based on a user's interaction with the dynamic tree view. In some embodiments, the dynamic tree view provides a visual representation of conflicting logic rules or conflicting logic chains within the set of logic rules. In some embodiments, the set of logic rules and the received updates to the set of logic rules define at least one requirement for an outcome. In some embodiments, the set of logic rules comprise a chain of categorization logic rules or chain of resource logic rules. In some embodiments, the dynamic tree view shows left to right, top to bottom how a transaction flows according to the set of logic rules. In some embodiments, the dynamic tree view depicted the set of logic rules in plain or conversational language. In some embodiments, the dynamic tree view depicted cascading rules left to right and nested rules vertically. In some embodiments, the user-interface allow a user to run scenarios on various logic rules within the dynamic tree view for assigning transactions prior to committing an update to the set of logic rules. In some embodiments, the methods comprise: processing transaction data through the set of logic rules, once updated, to categorize the transaction data and determine a resource to assign to a transaction associated with the transaction data.

Particular embodiments of the subject matter described in this disclosure can be implemented so as to realize one or more of the following advantages. The described system increased the accuracy of assigning the best resource for a transaction. For example, overall drive time for field resources is reduced and the most qualified resource (e.g., in terms of skillset, licenses, certifications) is assigned to the transaction. The described system also provides task-based assignment of multiple resources per transaction.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided. Moreover, various aspects of the systems described herein may be applied to any of the particular applications set forth below or for any other types of the data processing system disclosed herein. Any description herein concerning the data processing may apply to and be used for any other data processing situations. Additionally, any embodiments disclosed in the context of the data processing system or apparatuses are also applicable to the methods disclosed herein.

The details of one or more embodiments of the present disclosure are set forth in the accompanying drawings and the description below. Other features and advantages of the present disclosure will be apparent from the description and drawings, and from the claims.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIGS. 1A and 1B depict a non-limiting example interface that includes a custom territory;

FIGS. 2A and 2B depict non-limiting example nested logical rules that can be provided by embodiments of the present disclosure;

FIGS. 3A and 3B depict non-limiting example tree views that can be provided by embodiments of the present disclosure;

FIGS. 4A-4E depict various non-limiting example pages of a user-interface (UI) proved by the described resource assignment system;

FIG. 5 depicts a flowchart of a non-limiting example process that can be implemented by embodiments of the present disclosure;

FIG. 6 depicts a non-limiting example a computer system that can be programmed or otherwise configured to implement methods or systems of the present disclosure;

FIG. 7A depicts a non-limiting example environment that can be employed to execute embodiments of the present disclosure;

FIG. 7B depicts a non-limiting example application provision system that can be provided through an environment and employed to execute embodiments of the present disclosure; and

FIG. 7C depicts a non-limiting example cloud-based architecture of an application provision system that can be provided through an environment and employed to execute embodiments of the present disclosure.

### DETAILED DESCRIPTION

Described herein, in certain embodiments, are resource assignment systems comprising: a personal computing device; one or more processors; and a computer-readable storage device coupled to the one or more processors. The storage device having instructions stored thereon which, when executed by the one or more processors, cause the one or more processors to perform operations. These operations comprise: maintaining, in a datastore, a chain of categorization logic rules and a chain of resource logic rules, wherein the chain of categorization logic rules and the chain of resource logic rules are updated through a user-interface based on a respective Boolean-based visual representation of the chain of categorization logic rules and the chain of resource logic rules, and wherein each of the Boolean-based visual representations includes a representation of a logic chain formed by the respective chain of logic rules; receiving transaction data regarding a transaction, the transaction data comprising key attributes of the transaction; processing the transaction data through the chain of categorization logic rules to categorize the transaction based on the key attributes; processing the transaction data through the chain of resource logic rules to determine a resource to assign to the transaction, the chain of resource logic rules determined based on the categorization of the transaction; and deploying the resource to the transaction by providing a notification to the resource via the personal computing device.

Also described herein, in certain embodiments, are computer-implemented methods for assigning and deploying resources for incoming transactions. The methods are executed by one or more processors and comprise: maintaining, in a datastore, a chain of categorization logic rules and a chain of resource logic rules, wherein the chain of categorization logic rules and the chain of resource logic rules are updated through a user-interface based on a respective Boolean-based visual representation of the chain of categorization logic rules and the chain of resource logic rules, and wherein each of the Boolean-based visual representations includes a representation of a logic chain formed by the respective chain of logic rules; receiving transaction data regarding a transaction, the transaction data comprising key attributes of the transaction; processing the transaction data through the chain of categorization logic rules to categorize the transaction based on the key attributes; processing the transaction data through the chain of resource logic rules to determine a resource to assign to the transaction, the chain of resource logic rules determined based on the categorization of the transaction; and deploying the resource to the transaction by providing a notification to the resource via the personal computing device.

Also described herein, in certain embodiments, are non-transitory computer-readable storage media that are coupled to one or more processors. The one or more non-transitory computer-readable storage media having instructions stored thereon which, when executed by the one or more processors, cause the one or more processors to perform operations. These operations comprise: maintaining, in a datastore, a chain of categorization logic rules and a chain of resource logic rules, wherein the chain of categorization logic rules and the chain of resource logic rules are updated through a user-interface based on a respective Boolean-based visual representation of the chain of categorization logic rules and the chain of resource logic rules, and wherein each of the Boolean-based visual representations includes a representation of a logic chain formed by the respective chain of logic rules; receiving transaction data regarding a transaction, the transaction data comprising key attributes of the transaction; processing the transaction data through the chain of categorization logic rules to categorize the transaction based on the key attributes; processing the transaction data through the chain of resource logic rules to determine a resource to assign to the transaction, the chain of resource logic rules determined based on the categorization of the transaction; and deploying the resource to the transaction by providing a notification to the resource via the personal computing device.

Certain Definitions

Unless otherwise defined, all technical terms used herein have the same meaning as commonly understood by one of ordinary skill in the art to which this disclosure belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, the term “real-time” refers to transmitting or processing data without intentional delay given the processing limitations of a system, the time required to accurately obtain data and images, and the rate of change of the data and images. In some examples, “real-time” is used to describe the presentation of information obtained from components of embodiments of the present disclosure.

As used herein, the term “resource” refers to a Person, Place or Object.

As used herein, the term “ruleset” refers to a rule or grouping of rules that create a customized algorithm. In some embodiments, the customized algorithm reads through a dataset (FNOL) to determine, for example, a routing path to a transaction and the number of resources that should be assigned to the transaction.

### Resource Assignment System

The described resource assignment system assigns resources to incoming transactions. In some embodiments, territories are generated and associated with a resource based on a location of the resource. In some embodiments, users can create logics rules that can be used to assign a resource(s) to an incoming transaction. In some embodiments, a UI provided by the described system allows users to visualize and administer logical rules and the relationships among the logic rules. The rule visualization allows users to understand and configure how the system is automatically assigning resources to, for example, loss events. In some embodiments, the rule visualization is presented as a tree view. In some embodiments, the described system provides a resource management module that can be employed to manage internal and external parties that may be assigned to a transaction. For example, the resource management module can be employed to manage information about a resource, such as skills, certificates, license, available, and so forth.

In some embodiments, the described system leverages multiple subsystems to assist in the overall assignment of resources. In some embodiments, these subsystem employ machine learning to learn over-time and improve resource recommendations. For example, a subsystem may employ a feedback loop that synchronizes transaction data with internal claims management systems (CMSs) used by resource manager and other external parties during the life of the transaction.

Resource Assignment

In some embodiments, an auto assignment engine processes FNOL data to determine key attributes of a transaction and assigned resources to the transaction. In some embodiments, the determined key attributes are processed through a series or chain of logic rules that can be both cascading and nested to identify the best-fit resource(s) available within the system. These logic rules may include determining factors and requirements such as resource type, resource skill, resource, coverage areas (e.g., based on state, zip codes, or expansion zip codes). In some embodiments, the FNOL data and data regarding the determined best-fit resource(s) data are processed to determine the type of transaction, assignments of a resource(s) to the transaction, and the overall requirements of the each assigned resource. In some embodiments, the system may process the FNOL data through a chain of logic rules to categorize the transaction (e.g., determine an appropriate business line) and then process the FNOL data though a chain of logic rules associated with the respective category to determine a best-fit resource. For example, a transaction may be categorized as a claim for a vehicle (e.g., automobile or boat) or a home. The system may then process the FNOL data with a ruleset for specific resources assigned to handle vehicle claims or home claims respectively.

In some embodiments, resources are assigned to a transaction based on distinct attributes from a geographical prospective. These attributes include 1) resource type and availability, 2) coverage area, and 3) proximity to a transaction. In some embodiments, the coverage area is determined based on a state, zip code or geo-fencing within a given radius or a unique polygon. In some embodiments, proximity to a transaction becomes a factor when a coverage area includes multiple resources who can cover the transaction. For example, resources are weighted based on current geographical location feeds for each resource (e.g., provided by a device through an application) as well as a current assigned workload. As an example, if resource A and B cover the same area, but resource B is 3 miles from a transaction (e.g., a claim) and resource A is 10 miles away from the transaction, then, in some embodiments, resource B is the most optimal resource.

Example factors that can be included in the chain of logic rules used to determine best-fit resource(s) for a transaction include, but are not limited to: the business line will handle the transaction; the number of parties required to handle the transaction; the skills, licenses, certifications, etc. that are required by parties involved in the transaction; geographic location of the transaction in respect to coverage area of resources to be assigned; resource availability (e.g., is the resource in or out of the office); the overall capacity of a resource (resource capacity); and any overflow requirements (e.g., rules that trigger when all resources are overloaded or at a particular capacity).

Once a best fit resource is determined, the describe system then deploys the resource. For example, the system may provide a personal computing device associated with a resource information regarding the location of an assigned transaction. Other information may also be provided to the resource via the associated person computing device such as, relevant transaction data, deadlines, contact information, and so forth. As another example, a facility may be assigned to a transaction and scheduling information may be sent to the resources regarding when the facility will receive items associated with the transaction. As yet another example, a vehicle, such as a drone, may be assigned to a transaction. An assigned operator of the vehicle or a coordinator of a facility where the vehicle is located, may receive information regarding the assigned of the transaction and the assigned role of the vehicle. As another example, an IoT device may be installed at a location associated with the transaction. The IoT device may receive instructions to, for example, gather data or execute an operation based on the nature of the transaction. For example, a camera can be instructed to begin recording, an automated door may be instructed to open or close, a robot may be instructed to shut off of water value. Additionally, events may happen during the life of an open transaction where evidence is discovered that might require a reassignment process to occur to move the transaction toward a straight-through process (STP) (see STP section below).

Territory Generation

In some embodiments, the resource territory generation and assignment solution integrates advanced mapping capabilities that permit users to create resource-oriented territories directly within a map view. For example, resources can be geo-fenced inside radii or polygon based customized territories. These customized territories can be employed to minimizing drive time to visit, for example, policy holder claim sites. In some embodiments, the customized territories are generated by taking into consideration man-made barriers, such as bridges, highways, roadways, and so forth as well as natural barriers, such as rivers, lakes, marshes, parks, mountains, marshes and so forth. As such, the customized territories generated based-on these barriers are vastly superior to static territories, which are typically assigned by, for example, state, county, zip codes, and thus are crude and inefficient.

In some embodiments, the use of radii or polygons provides for contiguous, slightly intersecting or heavily overlapping territories to best handle the Policies-In-Force (PIF) densities in areas. By employing radii and custom polygons to generate custom territories the geolocation and fencing around resources can be specifically tailored and finely tuned. For example, resources can be fenced down to a block radius to eliminate or dramatically reduce drive time, which accelerates the management of transactions. By employing these custom territories, the described system ensures fast responses to loss events, close proximity to policies in their territories, and minimal drive distances. For example, the described system can automatically assign resources to transactions (e.g., loss events) based on the location of resources to a respective custom territory. If a resource is outside of a respective custom territory, the system may assign a status to the resource indicting that the resource is no longer eligible to receive new claims until the resource returns (or is within a configurable distance) to their assigned territory(ies). In some embodiments, resources can have multiple custom territories (e.g., a home territory, a catastrophe assigned territory (CAT event), etc.). In some embodiments, a resource may be assigned one active custom territory, which allows for business need based temporary re-assignments.

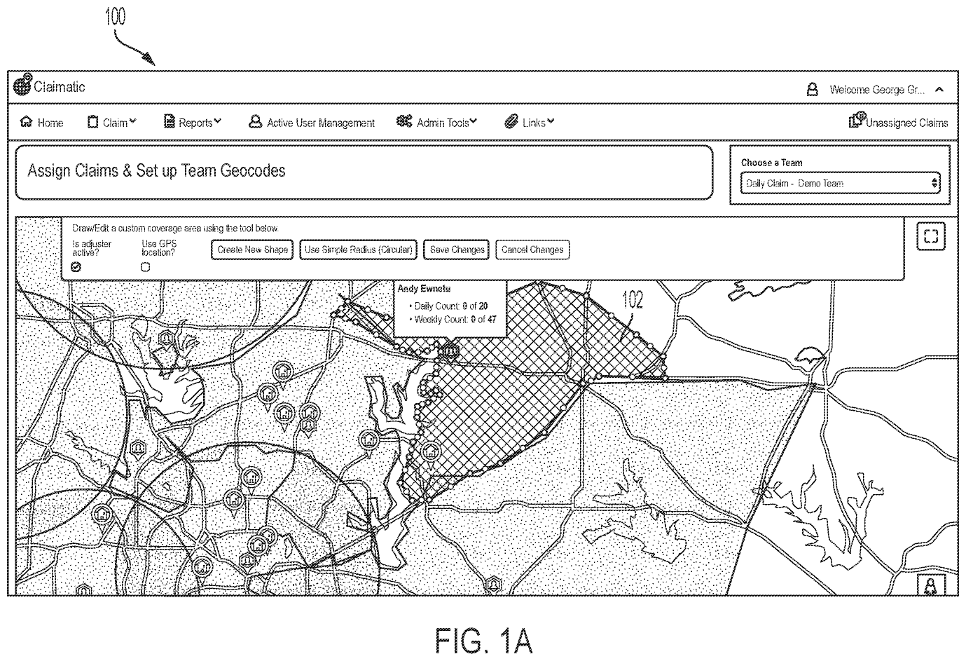

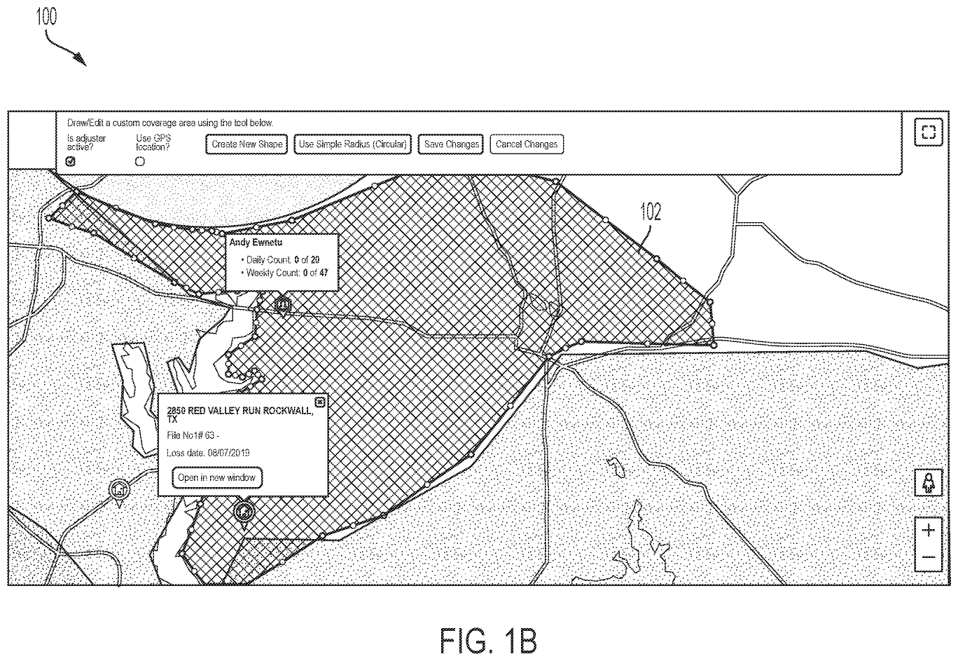

FIGS. 1A and 1B depict an example interface 100 that includes a custom territory 102. FIG. 1B depicts a zoomed in view on the custom territory 102. In some embodiments, the described system provides the interface 100 to allow users to create custom territories that can be employed in, for example, home territory assignment, resource planning, and active real-time resource deployment/re-deployment.

The depicted interface 100 shows how geo-fences can be drawn around a given resource such that the resource can be assigned more effectively based on respective rulesets governing the assignment of the resource. Such effective assignment improves efficiency by, for example, reducing drive time and overall speed at which the transaction is handled. As depicted, extreme precision can be exercised to formulate polygons that contour around man-made barriers (e.g., roads) and natural barriers (e.g., lakes) to handle fair territory sizing. In some embodiments, territory sizing is based on PIF densities, open claims, and so forth. In some embodiments, a polygon is used to determine the work territory of a resource, where that resource will only be assigned transactions that fall within the assigned territory(ies) or rather that fall inside of given vertices. In some embodiments, as an added restriction, users can enable dynamic tracking of a resource and prevent a resource from driving longer than a waited limit (e.g., 30 miles from their current location).

### Tree View

Logical rules can be compact initially within a system, but exceptions encountered in the operation of a system over time invariably add additional rules and conditions. The tree view provided through the described system is a Boolean-based visual representation of logic rules and the subsequent logic chain formed by such rules. In some embodiments, the tree view depicts logic rules as cascading or nested logic strings for easy comprehension. For example, a logic chain may be implemented to enforce how the system automatically assigns resources to custom territories. The tree view allows users to comprehend, troubleshoot, and correct conflicting logic rules within a logic chain or multiple logic chains. In some embodiments, the tree view exposes logic rules in a simple to view format, which allows for superior comprehension of the respective logic chain as well as identification of conflicts within the logic chain. In some embodiments, the described system provides logic rules driven by IF/AND/ELSE/BETWEEN/CONTAIN/GREATER THAN/LESS THAN statements that allow users customer to define their requirements for a given outcome.

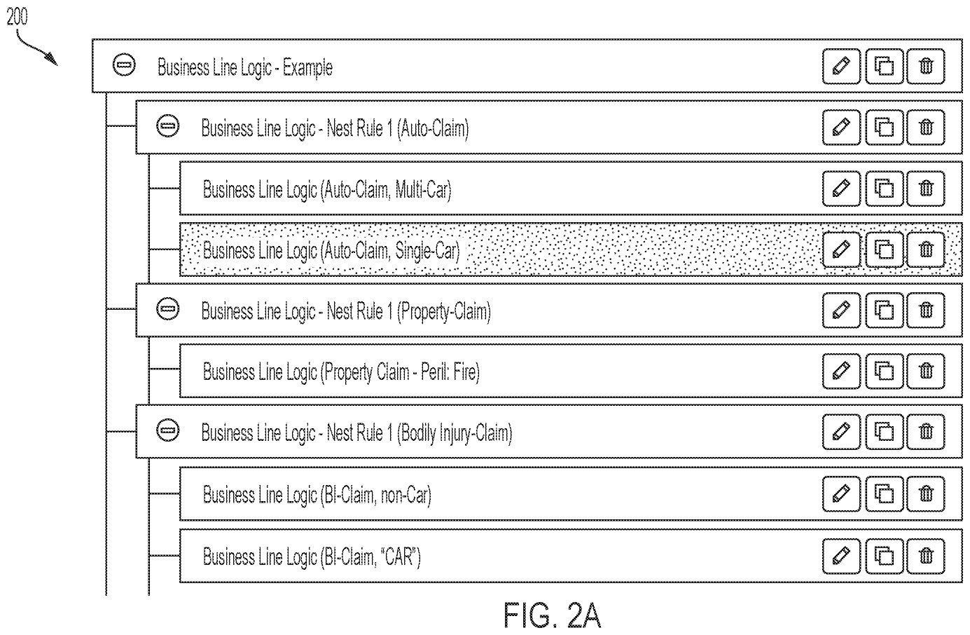

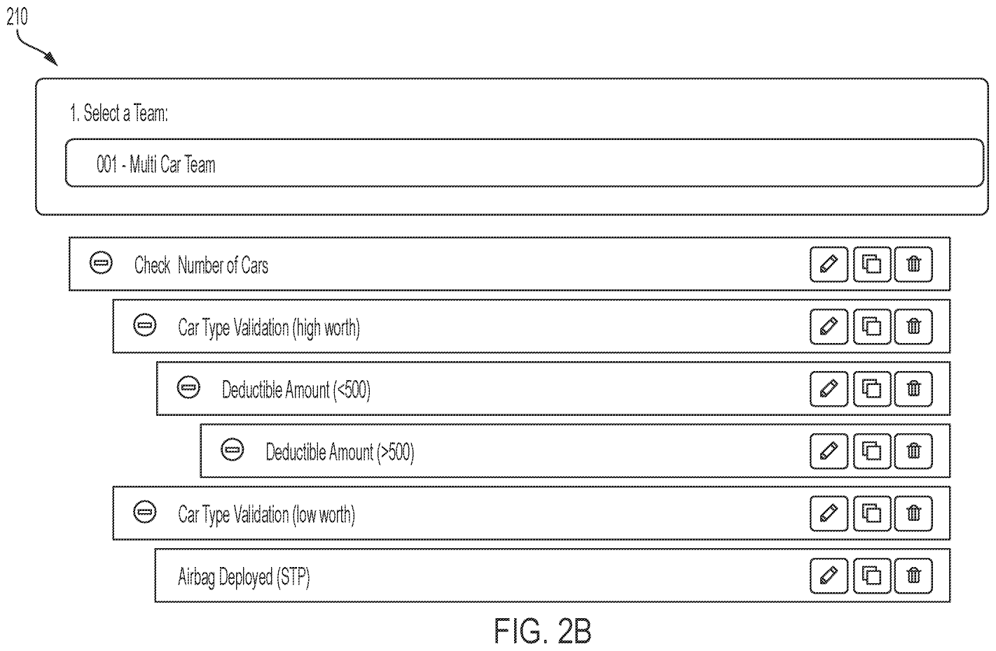

FIGS. 2A and 2B depict example nested logical rules 200 and 210 respectively. Each example shows a multi-tier chain of logic that is divided into multiple paths.

In some embodiments, the described system provides dynamic tree view to show left to right, top to bottom how a transaction flows through the system according to respective logic rules depicted in the tree view in plain or conversational language. Tree views may also show cascading rules left to right and nested rules vertically. With longer rule chains, these tree views become indispensable tools for handling the technical challenge of understanding, troubleshooting the improving the logic rules over time. Tree views also allow users to, for example, run scenarios on various logic rules for the assignment of transactions prior to committing a ruleset to improve results of claim assignment.

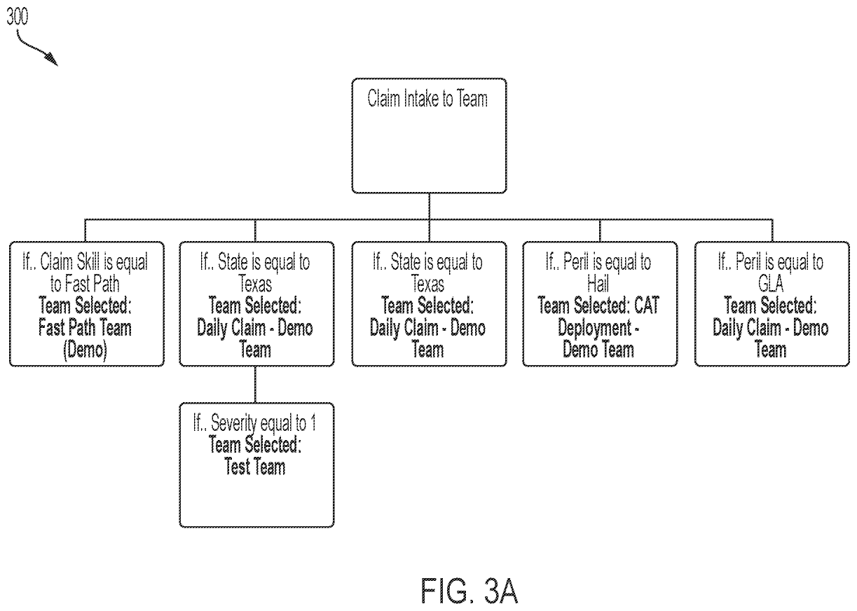

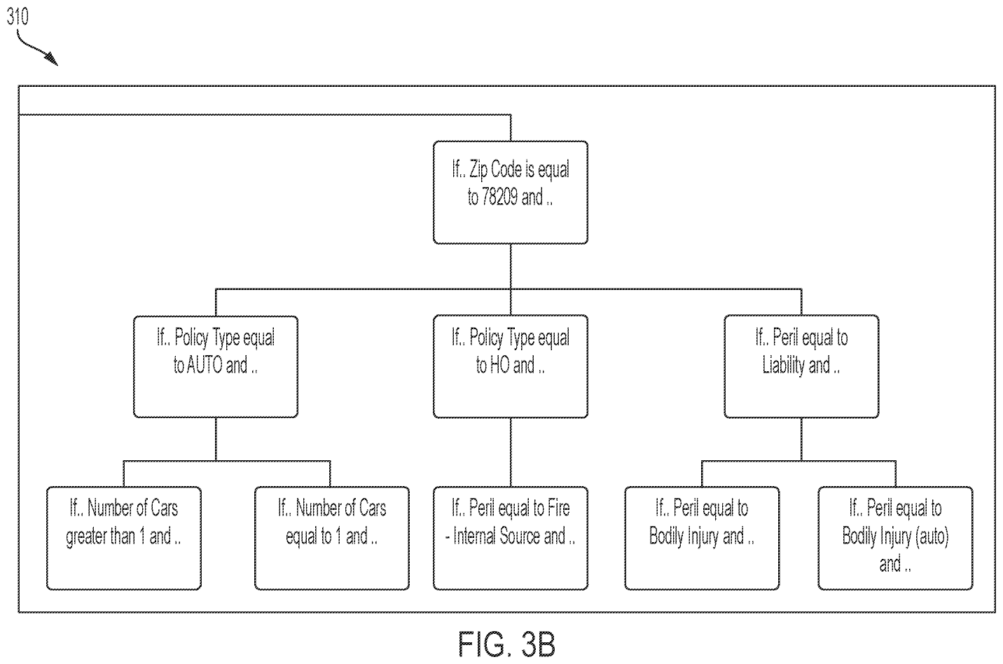

FIGS. 3A and 3B depict example tree views 300 and 310 respectively. Each of the tree views 300 and 310 include available logic rules presented in a readable, single compact pane.

### Example Pages

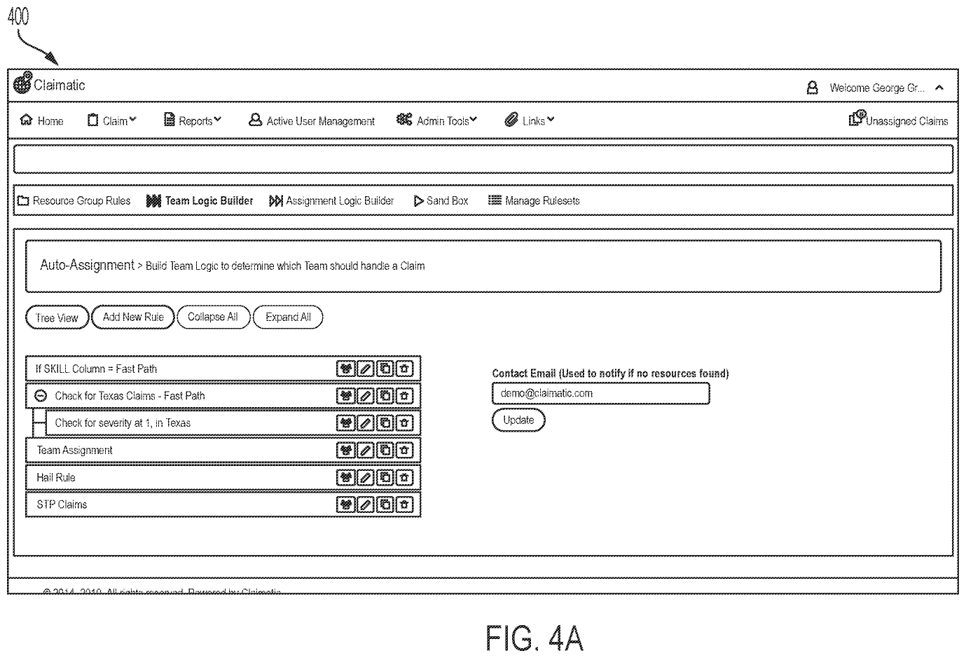

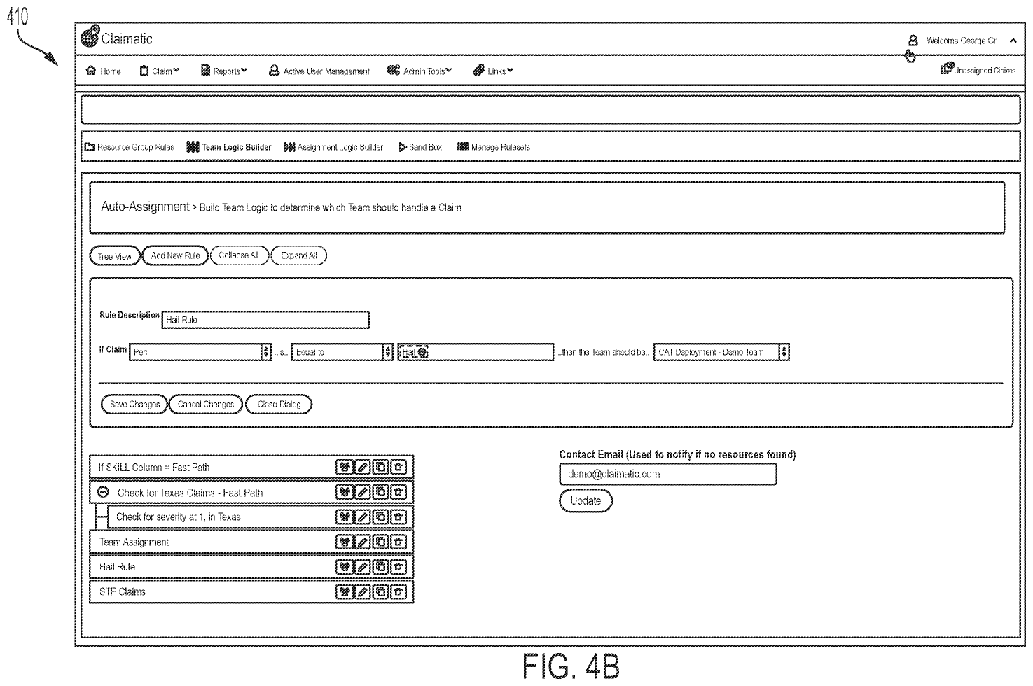

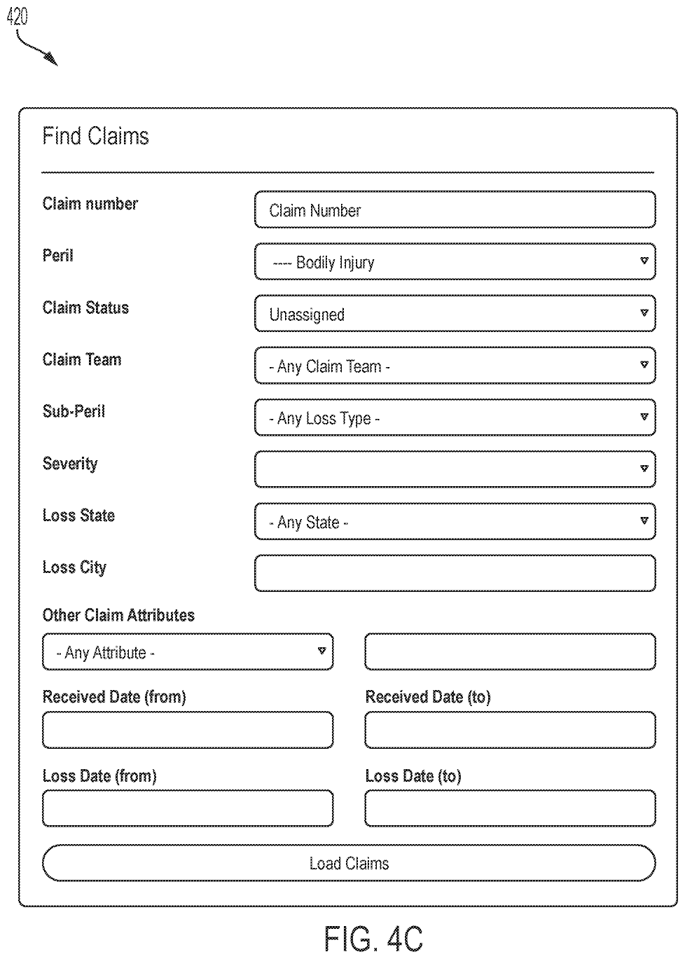

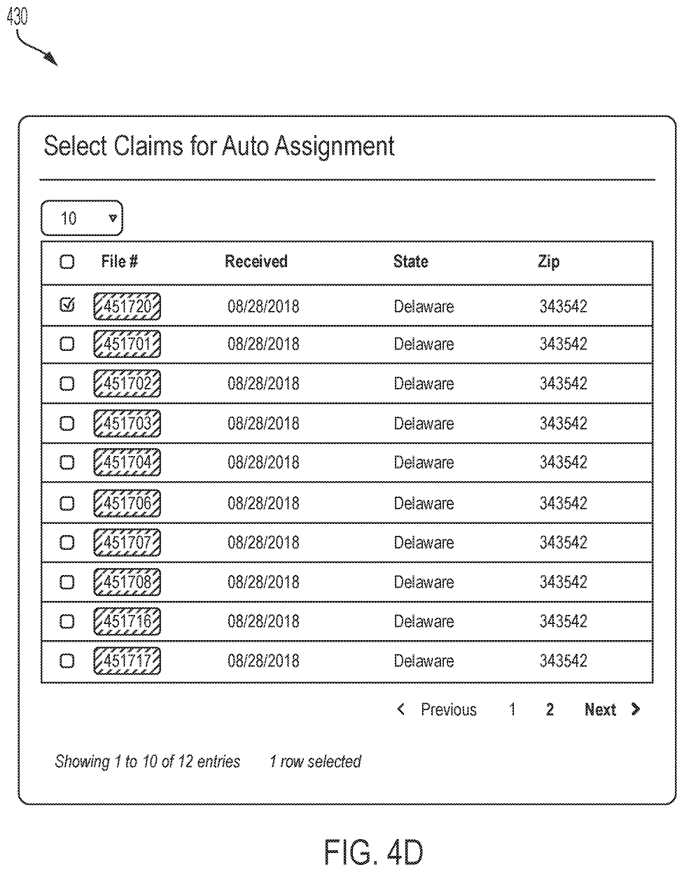

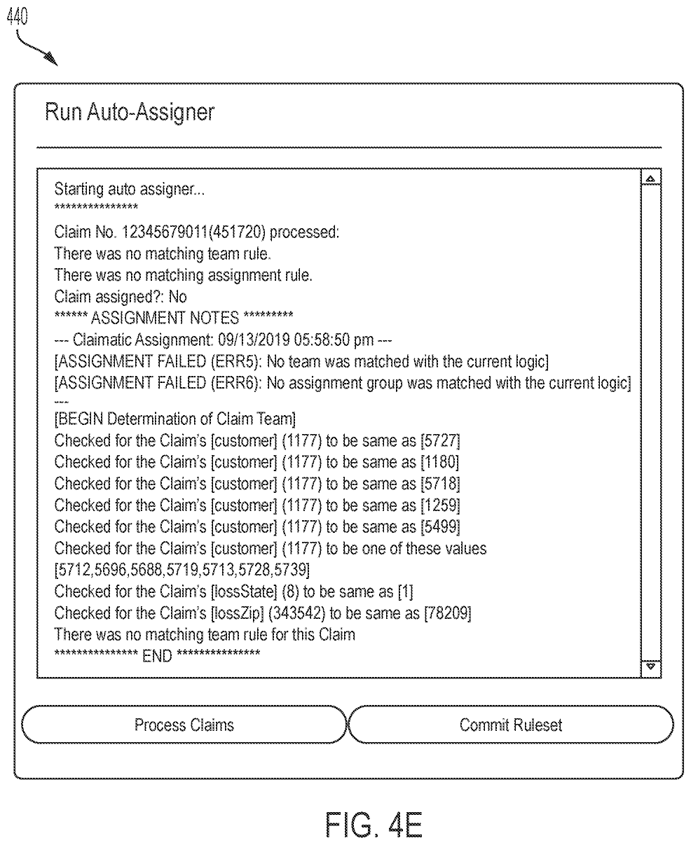

FIGS. 4A-4E depict various example pages provide by the described resource assignment system.

FIGS. 4A and 4B depict example Logic Builder pages 400 and 410 respectively. The depicted example pages show logic rules displayed in conversational language as well as how the logic rules can be configured as both cascading and nested respective to one another. The example page 410 depicted in FIG. 4B shows the “Hail Rule” as opened. In some embodiments, users can employ such Logic Builder pages to, for example, generate new logic rules, view and update existing logic rules, configure the relationship (e.g., order) among logic rules, and so forth.

FIGS. 4C, 4D, and 4E depict various pages 420, 430, and 440 that provide users with a safe sandbox functionality. This safe sandbox provides users a safe area where they can test system configuration updates (e.g., logic rules) before deploying or activating them. For example, users test updates to logic rules by running scenario-based assignments against the updates to test the yield of assignments based on these changes before deploying the changes to the live system. FIG. 4C depicts an example Find Claims page 420. FIG. 4D depicts an example Select Claims page 430. FIG. 4D depicts an example Run Auto-Assigner page 440.

### Example Processes

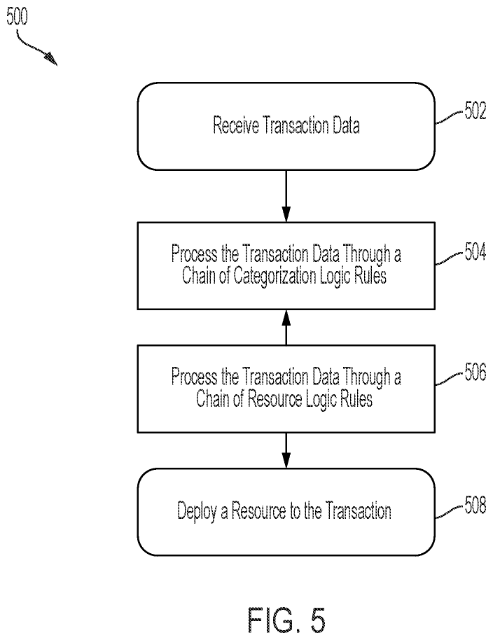

FIG. 5 depicts a flowchart of an example process 500 that can be implemented by embodiments of the present disclosure. The example process 500 can be implemented by the components of the described resource assignment system. The example process 500 generally shows in more detail how transaction data is processed through a chain of categorization logic rules and a chain of resource logic rules to determine a deploy a resource to a transaction. For clarity of presentation, the description that follows generally describes the example process 500 in the context of FIGS. 1A-4E and 6-7C. However, it will be understood that the process 500 may be performed, for example, by any other suitable system, environment, software, and hardware, or a combination of systems, environments, software, and hardware as appropriate. In some embodiments, various operations of the process 500 can be run in parallel, in combination, in loops, or in any order.

At 502, transaction data regarding a transaction is received. The transaction data includes key attributes of the transaction. In some embodiments, the key attributes include deadlines and contact information. In some embodiments, the transaction includes a loss event. In some embodiments, the transaction data includes a first notice of loss. From 502, the process 500 proceeds to 504.

At 504, the transaction data is processed through a chain of categorization logic rules to categorize the transaction based on the key attributes. From 504, the process 500 proceeds to 506.

At 506 the transaction data is processed through a chain of resource logic rules to determine a resource to assign to the transaction. In some embodiments, the chain of resource logic rules are determined based on the categorization of the transaction. In some embodiments, the chain of categorization logic rules and the chain of resource logic rules are maintained in a datastore. In some embodiment, the chain of categorization logic rules and the chain of resource logic rules are updated through a user-interface based on a respective Boolean-based visual representation of the chain of categorization logic rules and the chain of resource logic rules. In some embodiment, each of the Boolean-based visual representations includes a representation of a logic chain formed by the respective chain of logic rules. In some embodiments, the resource is assigned to the transaction based on a coverage area associated with the resource. In some embodiments, the resource is assigned to the transaction based on a proximity to the transaction. In some embodiments, the proximity to the transaction is determined by a current location of the resource. In some embodiments, the current location provided by a personal computing device associated with the resource. In some embodiments, the resource is assigned to the transaction based a skill set of the resource, licenses associated with the resource, certifications associated with the resource, availability of the resource, or overflow requirements. In some embodiments, the resource is assigned to the transaction based on a customized territory associated with the resource. In some embodiments, the customized territory is associated with the resource based on a current location of the resource. In some embodiments, the customized territory is determined based on radii or custom polygons that are tailored based on a topography of a region. In some embodiments, the topography of the region includes man-made barriers and natural barriers. In some embodiments, the chain of categorization logic rules and the chain of resource logic rules each include cascading and nested logic rules respectively. In some embodiments, the chain of categorization logic rules or the chain of resource logic rules is presented, via a user-interface, as a tree view. In some embodiments, the tree view includes a Boolean-based visual representation of the respective logic rules. In some embodiments, updates to the chain of categorization logic rules or the chain of resource logic rules are received from the user-interface. From 506, the process 500 proceeds to 508.

At 508, the resource is deployed to the transaction. In some embodiments, deploying the resource to the transaction comprises providing a notification to the resource via a personal computing device associated with the resource. In some embodiments, the notification comprises requirements assigned to the resources and instructions for the resource. In some embodiments, the instructions include traveling to a location associated with the transaction and assessing the transaction. In some embodiments, the resource is an individual, a vehicle, a piece of equipment, or an IoT device. From 508, the process 500 ends.

### Processing Devices and Processors

In some embodiments, the platforms, systems, media, and methods described herein include a computer, or use of the same. In further embodiments, the computer includes one or more hardware central processing units (CPUs) or general purpose graphics processing units (GPGPUs) that carry out the device's functions. In still further embodiments, the computer comprises an operating system configured to perform executable instructions. In some embodiments, the computer is optionally connected a computer network. In further embodiments, the computer is optionally connected to the Internet such that it accesses the World Wide Web. In still further embodiments, the computer is optionally connected to a cloud computing infrastructure. In other embodiments, the computer is optionally connected to an intranet. In other embodiments, the computer is optionally connected to a data storage device.

In accordance with the description herein, suitable computers include, by way of non-limiting examples, server computers, desktop computers, laptop computers, notebook computers, sub-notebook computers, netbook computers, netpad computers, handheld computers, Internet appliances, mobile smartphones, tablet computers, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the computer includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage or memory device. The storage or memory device is one or more physical apparatuses used to store data or programs on a temporary or permanent basis. In some embodiments, the device is volatile memory and requires power to maintain stored information. In some embodiments, the device is non-volatile memory and retains stored information when the computer is not powered. In further embodiments, the non-volatile memory comprises flash memory. In some embodiments, the volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, compact disc read-only memory (CD-ROM), digital versatile disc (DVD), flash memory devices, magnetic disk drives, magnetic tapes drives, optical disk drives, and cloud computing based storage. In further embodiments, the storage and/or memory device is a combination of devices such as those disclosed herein.

In some embodiments, the computer includes a display to send visual information to a user. In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In yet other embodiments, the display is a head-mounted display in communication with a computer, such as a virtual reality (VR) headset. In further embodiments, suitable VR headsets include, by way of non-limiting examples, HTC Vive, Oculus Rift, Samsung Gear VR, Microsoft HoloLens, Razer Open-Source Virtual Reality (OSVR), FOVE VR, Zeiss VR One, Avegant Glyph, Freefly VR headset, and the like. In still further embodiments, the display is a combination of devices such as those disclosed herein.

In some embodiments, the computer includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

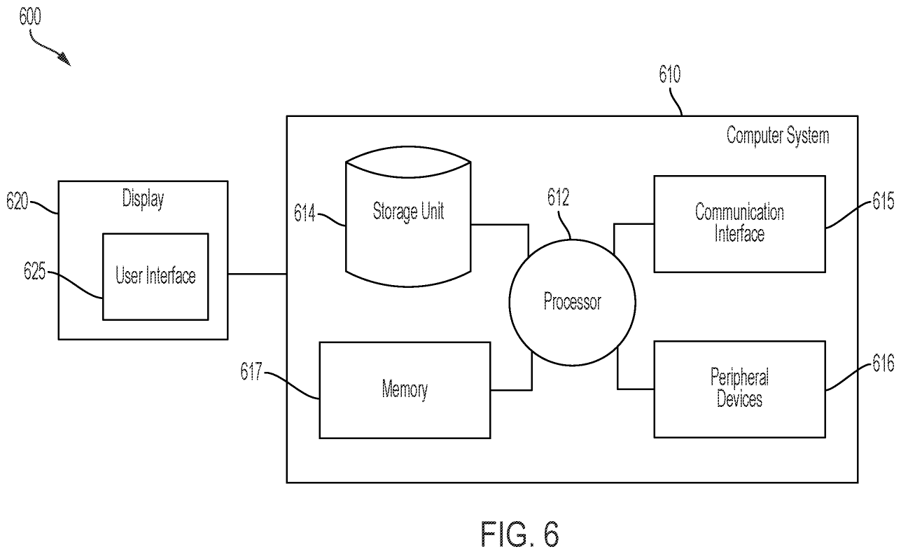

Computer control systems are provided herein that can be used to implement the platforms, systems, media, and methods of the disclosure. FIG. 6 depicts an example a computer system 610 that can be programmed or otherwise configured to implement platforms, systems, media, and methods of the present disclosure. For example, the computing device 610 can be programmed or otherwise configured to display a user-interface or application provided by the described resource assignment system.

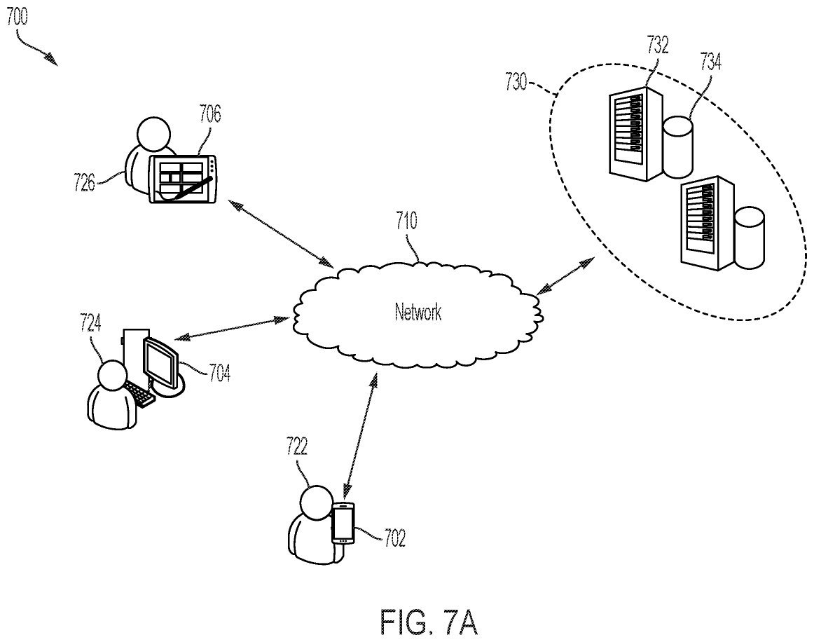

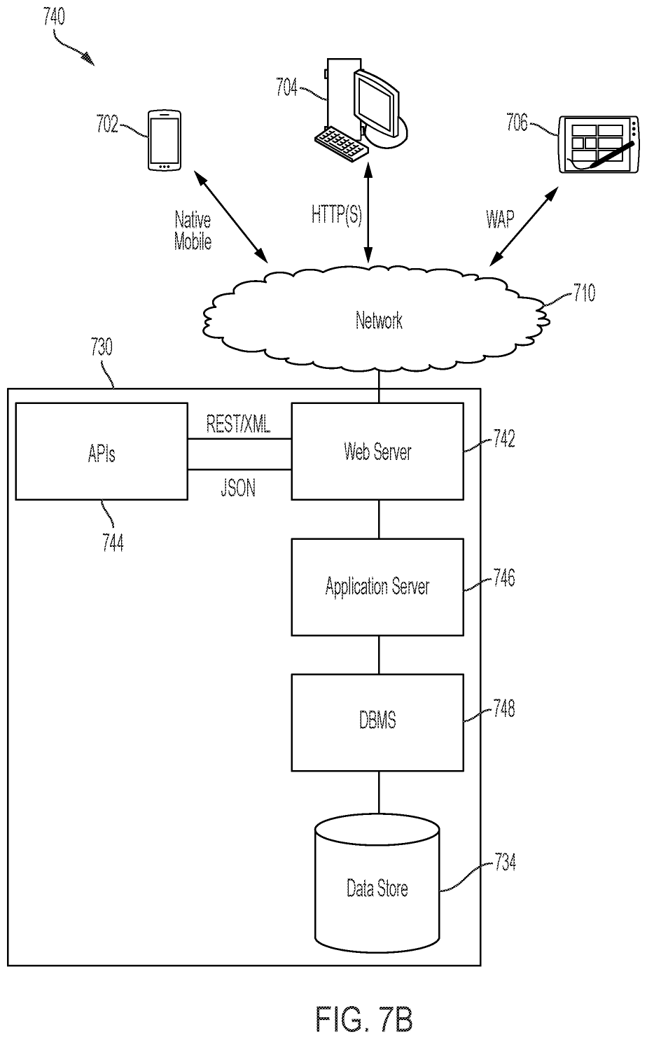

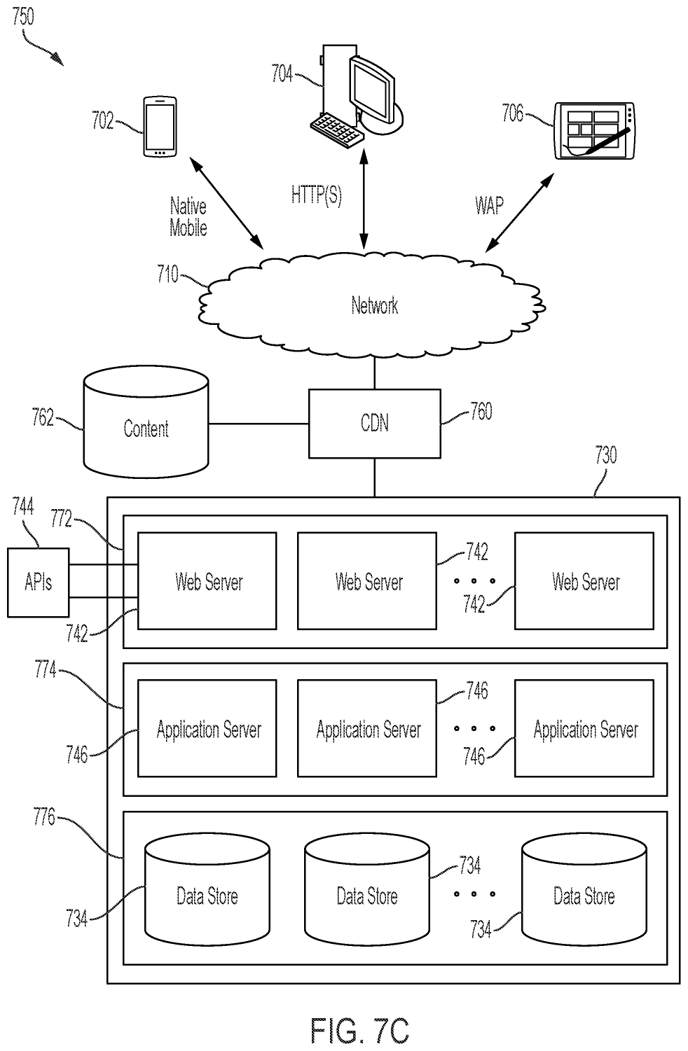

In the depicted embodiment, the computing device 610 includes a CPU (also “processor” and “computer processor” herein) 612, which is optionally a single core, a multi core processor, or a plurality of processors for parallel processing. The computing device 610 also includes memory or memory location 617 (e.g., random-access memory, read-only memory, flash memory), electronic storage unit 614 (e.g., hard disk), communication interface 615 (e.g., a network adapter) for communicating with one or more other systems, and peripheral devices 616, such as cache, other memory, data storage and/or electronic display adapters. In some embodiments, the memory 617, storage unit 614, interface 615 and peripheral devices 616 are in communication with the CPU 612 through a communication bus (solid lines), such as a motherboard. The storage unit 614 comprises a data storage unit (or data repository) for storing data. The computing device 610 is optionally operatively coupled to a computer network, such as the network 710 depicted and described in FIG. 7A, with the aid of the communication interface 615. In some embodiments, the computing device 610 is configured as a back-end server deployed within the described resource assignment system.

In some embodiments, the CPU 612 can execute a sequence of machine-readable instructions, which can be embodied in a program or software. The instructions may be stored in a memory location, such as the memory 617. The instructions can be directed to the CPU 612, which can subsequently program or otherwise configure the CPU 612 to implement methods of the present disclosure. Examples of operations performed by the CPU 612 can include fetch, decode, execute, and write back. In some embodiments, the CPU 612 is part of a circuit, such as an integrated circuit. One or more other components of the computing device 610 can be optionally included in the circuit. In some embodiments, the circuit is an application specific integrated circuit (ASIC) or a FPGA.

In some embodiments, the storage unit 614 stores files, such as drivers, libraries and saved programs. In some embodiments, the storage unit 614 stores user data, e.g., user preferences and user programs. In some embodiments, the computing device 610 includes one or more additional data storage units that are external, such as located on a remote server that is in communication through an intranet or the internet.

In some embodiments, the computing device 610 communicates with one or more remote computer systems through a network. For instance, the computing device 610 can communicate with a remote computer system. Examples of remote computer systems include personal computers (e.g., portable PC), slate or tablet PCs (e.g., Apple® iPad, Samsung® Galaxy Tab, etc.), smartphones (e.g., Apple® iPhone, Android-enabled device, Blackberry®, etc.), or personal digital assistants. In some embodiments, a user can access the computing device 610 via a network.

In some embodiments, the platforms, systems, media, and methods as described herein are implemented by way of machine (e.g., computer processor) executable code stored on an electronic storage location of the computing device 610, such as, for example, on the memory 617 or the electronic storage unit 614. In some embodiments, the CPU 612 is adapted to execute the code. In some embodiments, the machine executable or machine readable code is provided in the form of software. In some embodiments, during use, the code is executed by the CPU 612. In some embodiments, the code is retrieved from the storage unit 614 and stored on the memory 617 for ready access by the CPU 612. In some situations, the electronic storage unit 614 is precluded, and machine-executable instructions are stored on the memory 617. In some embodiments, the code is pre-compiled. In some embodiments, the code is compiled during runtime. The code can be supplied in a programming language that can be selected to enable the code to execute in a pre-compiled or as-compiled fashion.

In some embodiments, the computing device 610 can include or be in communication with an electronic display 620. In some embodiments, the electronic display 620 provides a UI 625 that depicts various screen such as the examples depicted in FIGS. 4A-4E.

FIG. 7A depicts an example environment 700 that can be employed to execute embodiments of the present disclosure. The example system 700 includes computing devices 702, 704, 706, a back-end system 730, and a network 710. In some embodiments, the network 710 includes a local area network (LAN), wide area network (WAN), the Internet, or a combination thereof, and connects web sites, devices (e.g., the computing devices 702, 704, and 706) and back-end systems (e.g., the back-end system 730). In some embodiments, the network 710 includes the Internet, an intranet, an extranet, or an intranet and/or extranet that is in communication with the Internet. In some embodiments, the network 710 includes a telecommunication or a data network. In some embodiments, the network 710 can be accessed over a wired or a wireless communications link. For example, mobile computing devices (e.g., the smartphone device 702 and the tablet device 706), can use a cellular network to access the network 710.

The described resource assignment system may be employed within the example environment 700 to, for example, assign resources to a transaction based on a ruleset and provide resource territory generation for each available resource.

In some examples, the users 722, 724, and 726 interact with the described resource assignment system through a graphical user-interface (GUI), such as depicted in FIGS. 4A-4E, or application that is installed and executing on their respective computing devices 702, 704, and 706. In some examples, the computing devices 702, 704, and 706 provide viewing data to screens with which the users 722, 724, and 726, can interact. In some embodiments, the computing devices 702, 704, 706 are sustainably similar to computing device 610 depicted in FIG. 6. The computing devices 702, 704, 706 may each include any appropriate type of computing device, such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. Three user computing devices 702, 704, and 706 are depicted in FIG. 7A for simplicity. In the depicted example environment 700, the computing device 702 is depicted as a smartphone, the computing device 704 is depicted as a tablet-computing device, and the computing device 706 is depicted a desktop computing device. It is contemplated, however, that embodiments of the present disclosure can be realized with any of the appropriate computing devices, such as those mentioned previously. Moreover, embodiments of the present disclosure can employ any number of devices as required.

In the depicted example environment 700, the back-end system 730 includes at least one server device 732 and at least one data store 734. In some embodiments, the device 732 is sustainably similar to computing device 610 depicted in FIG. 6. In some embodiments, the back-end system 730 may include server-class hardware type devices. In some embodiments, the server device 732 is a server-class hardware type device. In some embodiments, the back-end system 730 includes computer systems using clustered computers and components to act as a single pool of seamless resources when accessed through the network 710. For example, such embodiments may be used in data center, cloud computing, storage area network (SAN), and network attached storage (NAS) applications. In some embodiments, the back-end system 730 is deployed using a virtual machine(s). In some embodiments, the data store 734 is a repository for persistently storing and managing collections of data. Example data store that may be employed within the described system include data repositories, such as a database as well as simpler store types, such as files, emails, and so forth. In some embodiments, the data store 734 includes a database. In some embodiments, a database is a series of bytes or an organized collection of data that is managed by a database management system (DBMS).

In some embodiments, the at least one server system 732 hosts one or more computer-implemented services, such as described above, provided by the described resource assignment system. Users 722, 724, and 726 can interact with these services using, for example, their respective computing devices 702, 704, and 706. For example, a resource can employ a personal computing device to provide a current location to the system or to mark themselves as available for assignment to an incoming transaction.

FIG. 7B depicts an example application provision system 740 that can be provided through an environment, such as the example environment 700 and employed to execute embodiments of the present disclosure. As depicted, the example application provision system 740 includes the back-end system 730 configured to include one or more data stores 734 accessed by a DBMS 748. Suitable DBMSs include Firebird, MySQL, PostgreSQL, SQLite, Oracle Database, Microsoft SQL Server, IBM DB2, IBM Informix, SAP Sybase, SAP Sybase, Teradata, and the like. As depicted, the example application provision system 740 includes the back-end system 730 configured to include one or more application severs 746 (such as Java servers, .NET servers, PHP servers, and the like) and one or more web servers 742 (such as Apache, IIS, GWS and the like). The web server(s) 742 optionally expose one or more web services via an API 744 via the network 710. In some embodiments, the example application provision system 740 provides browser-based or mobile native UIs to the computing devices 702, 704, 706.

FIG. 7C depicts an example cloud-based architecture of an application provision system 750 that can be provided through an environment, such as the example environment 700, and employed to execute embodiments of the present disclosure. The application provision system 750 includes the back-end system 730 configured to include elastically load balanced, auto-scaling web server resources 772, application server resources 774, as well as synchronously replicated stores 776. In some embodiments, of the example cloud-based architecture of an application provision system 750, content 762 of services are provided through a content delivery network (CDN) 760 coupled with the back-end system 730. In some embodiments, a CDN is a geographically distributed network of proxy servers and respective data centers that provides high availability and high performance through distributing the service spatially relative to the receiving devices, such as commuting devices 702, 704, and 706.

### Non-transitory Computer Readable Storage Medium

In some embodiments, the platforms, systems, media, and methods disclosed herein include one or more non-transitory computer readable storage media encoded with a program including instructions executable by the operating system of an optionally networked computer. In further embodiments, a computer readable storage medium is a tangible component of a computer. In still further embodiments, a computer readable storage medium is optionally removable from a computer.

In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the computer's CPU, written to perform a specified task. Computer readable instructions may be implemented as program modules, such as functions, objects, API, data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and eXtensible Markup Language (XML) database systems. In further embodiments, suitable relational database systems include, by way of non-limiting examples, Microsoft SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or XML. In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®, or Google's® App Engine® In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile computer. In some embodiments, the mobile application is provided to a mobile computer at the time it is manufactured. In other embodiments, the mobile application is provided to a mobile computer via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C #, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Data Stores

In some embodiments, the platforms, systems, media, and methods disclosed herein include one or more data stores. In view of the disclosure provided herein, those of skill in the art will recognize that data stores are repositories for persistently storing and managing collections of data. Types of data stores repositories include, for example, databases and simpler store types, or use of the same. Simpler store types include files, emails, and so forth. In some embodiments, a database is a series of bytes that is managed by a DBMS. Many databases are suitable for receiving various types of data, such as weather, maritime, environmental, civil, governmental, or military data. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In some embodiments, a database is web-based. In some embodiments, a database is cloud computing-based. In some embodiments, a database is based on one or more local computer storage devices.

### Straight Through Process (STP)

A FNOL transaction is received where a homeowner has called and reported a small water leak in their vacation home. The leak has caused moderate damages to the property. Also, the homeowner has received a bid for repairs to the property. The described system processes the transaction to determine this the transaction is a pipe leak claim, with moderate damages based on a severity code. Additionally, system determines the coverage amount, deducible amount, and estimated repair cost based in the transaction data. The system determines that the claim exceeds a deducible and falls well below a coverage limit. Based on the determined information, the system assigns the transaction to an STP for immediate payment or a denial process of the transaction based on these new findings. As another example, should an assigned resources become unqualified to handle a transaction, the described system can update the transaction and reassign various parties based on this new information.

### Examples

### Hurricane

A transaction is received with a location in Tampa, Fla. that was caused by a hurricane. The transaction information includes that client is a high net worth individual and that the loss entails roof damage, interior damages, and that water is inside the house. This type of transaction requires several resources within the Tampa, Fla. area who can work on roofs and repair water damages. These resources also include water mitigation services and individuals who are trained to work on high net worth transaction. For example, the transaction might require a desk adjuster to oversee the transaction for the client, a roofing company to tarp and water seal the house, a water mitigation firm to remove water from the home and remediate damages, and a field adjuster who can work with the client and help them through the difficult experience as well as triage the overall claim process from the field. Thus, the system may assign four resources to the transaction based on the assignment rulesets trained according to data from the triage of similar events.

### Automobile 1

A transaction is received where a car has malfunctioned causing the driver to drive into a living room of a house, which injured a person sitting on a couch watching television TV. This transaction requires assigning multiple parties to a claim. For example, a primary claim could be assigned to desk examiner who manages sub-tasks for the claim. After the desk examiner has been assigned, described system determines and assigns a number of task-based assignments to various resources. Example assignments to resources to the transaction include: an assignment to an automobile appraiser to handle the damages to the car; an assignment to a bodily injury adjuster to work with the person who was injured, an assignment to a property adjuster to adjust the property damages. Later, through the discovery process, the assigned automobile appraiser discovers the braking system was defective and caused the accident. This information, mechanical defect presently under review, is provided to the described system, which then assigns a litigation attorney to the transaction to review and take appropriate action.

### Automobile 2

A car accident happens, and the owner begins a transaction. The transaction is filed as a simple collision with minor body damage because the car is drivable and not leaking fluids. The described system refers the owner to a Direct Repair Provider (DRP) who evaluates the car and discovered the car has frame damage and will cost more than the value of the car to repair. Thus, the DRP determines that the car a total loss. The DRP contacts the owner who is compensated accordingly. A preferred tow company is assigned by the system to move the car from the DRP to a salvage yard based on the feedback/updates provided for the transaction by the various assigned parties (e.g., the DRP).

### Property

A property owner opens a transaction after a hailstorm. A Significant Weather Observing Program (SWOP) has indicated that there is hail damage in the area to other property. The described system assigns a field resource and a desk resource (to provide governance) to the transaction. Upon inspection, the field resource determines that golf ball hail penetrated the roof of the property, and the air-conditioning system has received extensive damage. The described system processes the information provided by the field resource and assigns, based on trained AI models, a roofer and a heating, ventilation and air conditioning (HVAC) provider to the transaction. The described system may also assign additional resources from the assigned providers to handle the repairs.

### Transaction Count

The feedback system between clients CMSs and the described system can be employed to load balance the assignment of resources based on current assignment counts. Such a feedback loop allows transactions to be marked as “Closed,” which adjusts the number of claims an adjuster can have open at particular time. For example, an adjuster can be prescribed a caseload of ten currently opened transactions in the system. The feedback loop among the various the CMSs and described system keep the adjusters correct case load current in real-time along with the open count of all adjusters throughout the ecosystem. This allows for maximization of resource allocation within a given geographical area based on location and open claim counts.

### Assignment Improvement

As transactions are opened, closed, and otherwise moved through the system, transaction data is employed to trains various algorithms via machine learning. These trained models may then be employed within the described system to improve resource assignments/reassignments, open/close ratios, speed to closure, or average value of loss based on, for example, location, type of loss, or any other attributes associated to a transaction claim. The trained models may also be employed improve throughput via, for example, STP and reduce fraud risks and costs by lowering loss operating expenses (LOE) and operating expenses.

While preferred embodiments of the present subject matter have been shown and described herein, it will be obvious to those skilled in the art that such embodiments are provided by way of example only. Numerous variations, changes, and substitutions will now occur to those skilled in the art without departing from the described subject matter. It should be understood that various alternatives to the embodiments of the subject matter described herein may be employed.

What is claimed is:

1. A computer-implemented method for assigning and deploying resources for incoming transactions, the method being executed by one or more processors and comprising:
maintaining, in a datastore, a chain of categorization logic rules and a chain of resource logic rules, wherein the chain of categorization logic rules and the chain of resource logic rules are updated through a user-interface based on a respective Boolean-based visual representation of the chain of categorization logic rules and the chain of resource logic rules, and wherein each of the Boolean-based visual representations includes a representation of a logic chain formed by the respective chain of logic rules;
receiving transaction data regarding a transaction, the transaction data comprising key attributes of the transaction;
processing the transaction data through the chain of categorization logic rules to categorize the transaction based on the key attributes;
processing the transaction data through the chain of resource logic rules to determine a resource to assign to the transaction, the chain of resource logic rules determined based on the categorization of the transaction; and
deploying the resource to the transaction.

2. The method of claim 1, wherein deploying the resource to the transaction comprises providing a notification to the resource via a personal computing device associated with the resource, and wherein the notification comprises requirements assigned to the resources and instructions for the resource.

3. The method of claim 2, wherein the instructions comprise traveling to a location associated with the transaction and assessing the transaction.

4. The method of claim 1, wherein the key attributes comprise deadlines and contact information.

5. The method of claim 1, wherein the transaction comprises a loss event, and wherein the transaction data comprises a first notice of loss.

6. The method of claim 1, wherein the resource is assigned to the transaction based on a coverage area associated with the resource.

7. The method of claim 1, wherein the resource is assigned to the transaction based on a proximity to the transaction.

8. The method of claim 7, wherein the proximity to the transaction is determined by a current location of the resource, the current location provided by a personal computing device associated with the resource.

9. The method of claim 1, wherein the resource is assigned to the transaction based a skill set of the resource, licenses associated with the resource, certifications associated with the resource, availability of the resource, or overflow requirements.

10. The method of claim 1, wherein the resource is assigned to the transaction based on a customized territory associated with the resource.

11. The method of claim 10, wherein the customized territory is associated with the resource based on a current location of the resource.

12. The method of claim 10, wherein the customized territory is determined based on radii or custom polygons that are tailored based on a topography of a region.

13. The method of claim 12, wherein the topography of the region includes man-made barriers and natural barriers.

14. The method of claim 1, wherein the chain of categorization logic rules and the chain of resource logic rules each comprises cascading and nested logic rules respectively.

15. The method of claim 1, comprising:
presenting, via a user-interface, the chain of categorization logic rules or the chain of resource logic rules as a tree view, wherein the tree view comprises the Boolean-based visual representation of the respective logic rules.

16. The method of claim 15, comprising:
receiving updates to the chain of categorization logic rules or the chain of resource logic rules from the user-interface.

17. The method of claim 1, wherein the resource comprises an individual, a vehicle, a piece of equipment, or an Internet of Things (IoT) device.

18. A resource assignment system, comprising:
a personal computing device;
one or more processors; and
a computer-readable storage device coupled to the one or more processors and having instructions stored thereon which, when executed by the one or more processors, cause the one or more processors to perform operations comprising:
maintaining, in a datastore, a chain of categorization logic rules and a chain of resource logic rules, wherein the chain of categorization logic rules and the chain of resource logic rules are updated through a user-interface based on a respective Boolean-based visual representation of the chain of categorization logic rules and the chain of resource logic rules, and wherein each of the Boolean-based visual representations includes a representation of a logic chain formed by the respective chain of logic rules;
receiving transaction data regarding a transaction, the transaction data comprising key attributes of the transaction;
processing the transaction data through the chain of categorization logic rules to categorize the transaction based on the key attributes;
processing the transaction data through the chain of resource logic rules to determine a resource to assign to the transaction, the chain of resource logic rules determined based on the categorization of the transaction; and
deploying the resource to the transaction by providing a notification to the resource via the personal computing device, wherein the personal computing device is associated with the resource.

19. One or more non-transitory computer-readable storage media coupled to one or more processors and having instructions stored thereon which, when executed by the one or more processors, cause the one or more processors to perform operations comprising:
maintaining, in a datastore, a chain of categorization logic rules and a chain of resource logic rules, wherein the chain of categorization logic rules and the chain of resource logic rules are updated through a user-interface based on a respective Boolean-based visual representation of the chain of categorization logic rules and the chain of resource logic rules, and wherein each of the Boolean-based visual representations includes a representation of a logic chain formed by the respective chain of logic rules;
receiving transaction data regarding a transaction, the transaction data comprising key attributes of the transaction;
processing the transaction data through the chain of categorization logic rules to categorize the transaction based on the key attributes;
processing the transaction data through the chain of resource logic rules to determine a resource to assign to the transaction, the chain of resource logic rules determined based on the categorization of the transaction; and
deploying the resource to the transaction.

20. The media of claim 19, wherein the resource is assigned to the transaction based on a customized territory associated with the resource, wherein the customized territory is associated with the resource based on a current location of the resource, wherein the customized territory is determined based on radii or custom polygons that are tailored based on a topography of a region, and, wherein the topography of the region includes man-made barriers and natural barriers.

21. A computer implemented method for receiving updates to a set of logic rules, the method comprising:
maintaining, in a datastore, the set of logic rules comprising cascading or nested logic rules;
determining a Boolean-based visual representation of the set logic rules and a logic chain formed by the set logic rules as a dynamic tree view, wherein the dynamic tree view depicts the set of logic rules as cascading or nested logic strings for human readability;
providing the dynamic tree view to a user-interface; and
receiving updates to the set of logic rules from the user-interface based on a user's interaction with the dynamic tree view.

22. The method of claim 21, wherein the dynamic tree view provides a visual representation of conflicting logic rules or conflicting logic chains within the set of logic rules.

23. The method of claim 21, wherein the set of logic rules and the received updates to the set of logic rules define at least one requirement for an outcome.

24. The method of claim 21, wherein the set of logic rules comprise a chain of categorization logic rules or chain of resource logic rules.

25. The method of claim 21, wherein the dynamic tree view shows left to right, top to bottom how a transaction flows according to the set of logic rules.

26. The method of claim 21, wherein the dynamic tree view depicted the set of logic rules in plain or conversational language.

27. The method of claim 21, wherein the dynamic tree view depicted cascading rules left to right and nested rules vertically.

28. The method of claim 21, wherein the user-interface allow a user to run scenarios on various logic rules within the dynamic tree view for assigning transactions prior to committing an update to the set of logic rules.

29. The method of claim 21, comprising:
processing transaction data through the set of logic rules, once updated, to categorize the transaction data and determine a resource to assign to a transaction associated with the transaction data.
